(19) United States
(12) Patent Application Publication
(10) Pub. No.: US 2022/0082371 A1
(43) Pub. Date: Mar. 17, 2022

(54) FILM THICKNESS GAUGE BY NEAR-INFRARED HYPERSPECRAL IMAGING

(71) Applicant: Dow Global Technologies LLC, Midland, MI (US)

(72) Inventors: Xiaoyun Chen, Midland, MI (US); Jin Wang, Midland, MI (US); Michael M. Bishop, Indianapolis, IN (US); Christopher M. Thurber, Midland, MI (US); Matthew Benedict, Collegeville (PA); Hyunwoo Kim, Manvel, TX (US); Eric L. Marchbanks, Sanford, MI (US); Kurt W. Olson, Midland, MI (US)

(21) Appl. No.: 17/419,487

(22) PCT Filed: Jan. 22, 2020
(86) PCT No.: PCT/US2020/014499

§ 371 Date: Jun. 29, 2021

Related U.S. Application Data
(60) Provisional application No. 62/818,961, filed on Mar. 15, 2019.

(51) Int. Cl. G01B 11/06; B29C 48/10; B29C 48/00; B29C 48/92

(52) U.S. Cl. CPC G01B 11/06; B29C 48/10; B29L 2023/001; B29C 48/92; B29C 2948/92152; B29C 48/0018

(57) ABSTRACT

The present teachings include a method of measuring an entire film thickness. The method may include forming a polymeric film (10) and measuring the thickness of the film (10) with a camera (20) collecting spatial and spectral images of a plurality of points at one time. The camera may collect a line image from a line of the film. The camera may be a hyperspectral near-infrared camera. In analyzing raw data collected during the measuring step, fringes of the raw data may be corrected using a classical least squares analysis.

### FIELD

In general, the present teachings relate to measurement of a thickness of a film. More particularly, the present teachings are directed to a hyperspectral camera and use thereof for measuring the thickness of a film.

### BACKGROUND

Polymeric film materials are used in a wide range of products and packages. These film materials are often categorized as packaging or nonpackaging. Packaging films can be used for food applications, nonfood applications, and other applications. Food packaging films can be used, for example, for bags of produce, baked goods, breads, and candy; for wrapping meat, poultry, seafood, or candy; or for bags-in-a-box or boil-in-bags. Nonfood packaging films may be used, for example, in shipping sacks, bubble wrap, envelopes, and industrial liners. Other packaging may include stretch and shrink wrap. Nonpackaging film applications include grocery bags, can liners, agricultural films, construction films, medical and health care films, garment bags, household wraps, and even as a component in disposable diapers.

In producing these films, it is important to maintain a desired thickness and to reduce gauge variation in the film. It is also important to provide a plurality of data points, as when few data points are collected, it is possible to miss weak spots of a film.

One method of producing these films is through blown film processes. Systems to measure the thickness of films in a blown film process rely on an online thickness measurement device to send real-time film thickness to auto die or auto air rings to control the gauge variation. Currently, many types of thickness gauge technologies are used in the blown film industry.

Historically, gamma backscatter sensors or capacitance sensors have been used on the bubble in blown film applications to measure total thickness. Transmission sensors (e.g., beta, gamma, x-ray, and near-infrared) have been used on the collapsed bubble or two-layer film, also known as the layflat.

Traditional capacitance sensors must contact the film surface to measure the thickness. However, contacting the film risks tearing the film, and has certain limitations, as it is unable to measure a tacky film. Recently, compressed air has been used to control a small gap between the capacitance sensor and the film surface to overcome these drawbacks. However, the scan speed is very slow, and measurements are taken a single position at a time. Therefore, it cannot provide a whole film thickness profile. In addition, if being used in a blown film application, this requires a stable bubble. Any significant change of the bubble shape during production may push the sensor pin into the bubble and result in an upset of production.

Scanners such as beta, gamma, x-ray, and infrared are all single point scanning technologies. Therefore, they are also unable to provide a whole film thickness profile. Other gauges for measuring the thickness profile of a film are very expensive and are unable to scan wide films.

Notwithstanding efforts to improve measurement of film thicknesses or monitoring films (e.g., during production), there remains a need for measuring an entire film thickness at real time for better control of the process.

### SUMMARY

The present teachings make use of a simple, yet elegant, construction approach by which relatively few components can be employed for achieving measurement of a thickness of a sample. The measurement may be performed without contacting the sample. The measurement may be performed quickly and/or in real time. The measurement may occur on-line (e.g., during the process of forming the film, sheet, or plaque). The measurement may be performed off-line (e.g., after forming the film, sheet, or plaque).

The present teachings include a method including obtaining a polymeric film, sheet, or plaque and measuring the thickness thereof. The measuring step may be performed using a camera collecting spatial and spectral images of a plurality of points at a time. This may allow for measuring an entire film thickness and/or generating a whole film thickness profile. The camera may collect a line image from a line of the film, sheet, or plaque. The line image may include about 10 pixels or more, about 20 pixels or more, about 100 pixels or more, or even about 300 pixels or more. The spectral images may include about 10 pixels or more, about 20 pixels or more, about 100 pixels or more, or even about 300 pixels or greater. The spectral images may, for example, cover a wavelength of infrared and/or near-infrared (e.g., about 800 to 25,000 nm, about 12,500 to 400 cm⁻¹, or both). The camera may be a hyperspectral camera. The camera may be a hyperspectral near-infrared camera. The measuring step may be performed in real time. The measuring step may be performed in a machine direction. The measuring step may be performed in a cross-machine direction.

The film, sheet, or plaque may comprise polyethylene, polypropylene, polyester, nylon, polyvinyl chloride, cellulose acetate, cellophane, semi-embossed film, bioplastic, biodegradable plastic, or a combination thereof. The film may be formed from operations such as blowing, casting, extrusion, calender rolls, solution deposition, skiving, coextrusion, lamination, extrusion coating, spin coating, deposition coating, dip coating, or a combination thereof. The obtaining step may include forming a film using a blown film process. The blown film process may include forming a bubble of film. The measuring step may be performed on the bubble to determine the thickness of the bubble. A plurality of cameras may be mounted around the bubble to measure the whole bubble. A single camera may rotate around the bubble to measure the whole bubble. The blown film process may include collapsing a bubble of film to produce a layflat. The measuring step may be performed on the layflat to determine the layflat or one or more layers thereof.

The present teachings also contemplate the plotting and calculating of the thickness using the hyperspectral camera. Fringes of raw data collected in the measuring step may be corrected (e.g., using a classical least squares analysis).

The present teachings therefore allow for the measuring of a film, sheet, or plaque using hyperspectral imaging.

According to a first feature of the present disclosure, a method comprises the steps of: obtaining a polymeric film, sheet, or plaque; and measuring a thickness of the film, sheet, or plaque wherein the measuring step is performed using a camera collecting both spatial and spectral images of a plurality of points simultaneously. According to a second feature of the present disclosure, the camera collects a line image from a line of the film, sheet, or plaque. According to a third feature of the present disclosure, the film, sheet or plaque has thickness of 2 mm or less. According to a fourth feature of the present disclosure, the camera collects light having a wavelength of from 780 nm or greater to 2500 nm. According to a fifth feature of the present disclosure, a light source emitting light having a wavelength of from 780 nm or greater to 2500 nm is positioned on an opposite side of the polymeric film, sheet, or plaque than the camera. According to a sixth feature of the present disclosure, the method further comprises the step of forming the polymeric film using a blown film process. According to a seventh feature of the present disclosure, the blown film process comprises forming a bubble of film, and wherein the measuring step is performed on the bubble to determine the thickness of the film forming the bubble. According to an eighth feature of the present disclosure, the blown film process comprises collapsing a bubble of film to produce a layflat, and wherein the measuring step is performed on the layflat to determine the thickness of the layflat or one or more layers thereof.

### BRIEF DESCRIPTION OF THE DRAWINGS

FIG. 1 is an illustration of measuring a film thickness using a known scanner.

FIG. 2 is an illustration of measuring a film thickness in accordance with the present teachings.

FIG. 3 is an illustrative blown film line and positioning of cameras for measuring the film in accordance with the present teachings.

FIGS. 4A and 4B illustrate exemplary positions of cameras to measure the thickness of a film bubble in accordance with the present teachings.

FIG. 5 is a comparison of measurements by an x-ray scanner and a hyperspectral NIR camera on a film sample.

FIG. 6 illustrates a CLS-based fringe removal approach on a 1-mil film.

FIG. 7 illustrates a CLS-based fringe removal approach on a 0.5-mil film.

FIG. 8 illustrates a film thickness map based on the CLS analysis.

### DETAILED DESCRIPTION

As required, detailed embodiments of the present teachings are disclosed herein; however, it is to be understood that the disclosed embodiments are merely exemplary of the teachings that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present teachings.

In general, and as will be appreciated from the description that follows, the present teachings pertain to methods and apparatuses for measuring thickness of a material, such as film, sheet, plaque, or the like. The measurements may provide a whole thickness profile of the article. Providing a thickness profile may allow for defects to be discovered or may ensure that the material meets required specifications. The measurement may allow for adjustments to be made during processing. This may allow for changes to be made while the material is being formed, without requiring shutdown of the manufacturing process. The thickness measurements may be used to provide automatic feedback (e.g., in a control system to bring the thickness back to a target value). The measurement may occur in-line, during manufacturing. The measurement may occur after the material has been formed (e.g., off-line). It is contemplated that the present teachings may also be employed for measuring or detecting crystallinity of a material. The present teachings may also be employed for measuring or detecting impurities and/or foreign particles in a material.

While referred to herein as films for simplicity, it is within the scope of the teachings that the methods and apparatuses herein are capable of measuring films having a thickness of about 250 microns or less (e.g., ranging from about 1 to about 250 microns), sheets having a thickness of about 250 microns or greater and/or about 2000 microns or less, plaques having a thickness of about 2 mm, and the like. A film may be a thin, continuous polymeric material. A sheet may be a thicker polymeric material than a film. Where a film is mentioned herein, it is contemplated that said discussion is also referring to and/or includes these other articles for measurement.

The films to be measured may be transparent. The films may be translucent. The films may be opaque. The films may be clear. The films may be colored. The films may be flexible. The films may be rigid. The films may have different properties depending on the application. The films may provide stiffness, toughness, performance on automated packaging equipment, robust processability, or a combination thereof. The films may meet desired puncture, secant modulus, tensile yield point, tensile break point, dart drop impact strength, Elmendorf tear strength, gloss, haze, the like, or a combination thereof. The film may be capable of acting as a barrier to gas, liquids, or moisture. The film may instead be permeable. A film may act as a membrane. The film may be useful in a variety of applications, including, but not limited to, packaging, plastic bags, labels, building construction, landscaping, electrical fabrication, photographic film, film stock (e.g., for movies), the like, or a combination thereof. The film may be used as a thermoshrinkable film, cover or protective film, embossed film, or film for lamination, for example.

The films to be measured may be formed of or include a polymeric material. The film may include polyethylene resin, such as low density polyethylene (LDPE), linear low density polyethylene (LLDPE), metallocene linear low density polyethylene (mLLDPE), ultra low density polyethylene (ULDPE), very low density polyethylene (VLDPE), medium density polyethylene (MDPE), a high molecular weight HDPE (HMWHDPE), high density polyethylene (HDPE), or a combination thereof. The film may include polyethylene terephthalate (PET). The film may include polyethylene terephthalate glycol (PETG). The film may include polypropylene resin. The film may include polypropylene homopolymer or polypropylene copolymer. Exemplary homopolymers include homopolymer polypropylene (hPP), random copolymer polypropylene (rcPP), impact copolymer polypropylene (hPP+at least one elastomeric impact modifier) (ICPP) or high impact polypropylene (HIPP), high melt strength polypropylene (HMS-PP), isotactic polypropylene (iPP), syndiotactic polypropylene (sPP), and combinations thereof. Examples of homopolymer propylenes that can be used in the present teachings include homopolymer propylenes commercially available from LyondellBasell Industries (e.g., Pro-fax PD702), from Braskem (e.g., D115A), and from Borealis (e.g., WF 420HMS). The film may include a propylene-alpha-olefin interpolymer. The propylene-alpha-olefin interpolymer may have substantially isotactic propylene sequences. The propylene-alpha-olefin interpolymers include propylene based elastomers (PBE). “Substantially isotactic propylene sequences” means that the sequences have an isotactic triad (mm) measured by 13C NMR of about 0.85 or greater; about 0.90 or greater; about 0.92 or greater; or about 0.93 or greater. The film may include EPDM materials. The film may include polyvinyl chloride (PVC) resin. The film may include nylon resin (e.g., PA6). The film may include polyester. The film may include a polypropylene-based polymer, ethylene vinyl acetate (EVA), a polyolefin plastomer, a polyolefin elastomer, an olefin block copolymer, cyclic olefin copolymer (COC), an ethylene acrylic acid, an ethylene methacrylic acid, an ethylene methyl acrylate, an ethylene ethyl acrylate, an ethylene butyl acrylate, an isobutylene, a polyisobutylene, a maleic anhydride-grafted polyolefin, an ionomer of any of the foregoing, or a combination thereof. Films may include polyvinylidene chloride (PVDC), ethylene vinyl alcohol (EVOH), polystyrene (PS) resins, high impact polystyrene (HIPS), polyamides (e.g., copolyamide (CoPA)), or a combination thereof. The film may be formed from cellulose acetate, cellophane, semi-embossed film, bioplastic and/or biodegradable plastic, the like, or a combination thereof.

The film may include one or more additives. For example, the film may include one or more plasticizers, antioxidants, colorants, slip agents, anti-slip agents, antiblock additives, UV stabilizers, IR absorbers, antistatic agents, processing aids, flame retardant additives, cleaning compounds, blowing agents, degradable additives, color masterbatches, the like, or a combination thereof.

In an exemplary process, extruded film material may be formed using a blown film extrusion process. The process may include extruding a tube of molten polymer through a die and inflating the polymer to form a thin bubble. The bubble may be compressed and then rolled into a roll, cut into sheets, or the like.

In more detail, polymer pellets, resin, raw materials, and/or other materials may be fed into a hopper. The input material is then directed into an extruder unit and melted. The polymeric melt is extruded through an annular slit die. Air is introduced into the center of the die to blow up the tube into a bubble. An air ring may cause the hot film to cool by blowing air on the inside and/or outside surface of the bubble. The bubble may then be directed upward toward one or more nip rolls, where the bubble is then collapsed or flattened. The collapsed tube is then directed through one or more idler rollers. The collapsed tube may be sent to a winder to wind the film into rolls. The process may result in a flat film.

The properties of the material and/or appearance of the material may be a result of the processing method and/or conditions. The film may be free of, or at least substantially free of wrinkles. This may be a result of the collapsing process of changing from a round shape to a flat shape. The film may have optical properties that are affected by the raw material type and/or melt quality of the extruder. The mechanical properties of the film may be affected by the orientation of the molecular structure during the production process, such as the blowing process. The mechanical properties may be impacted by the raw material used. The thickness of the film may be affected by the temperature profile during the production process.

While the present teachings are discussed in the context of blown film, use of other film production methods are within the scope of the present teachings. The methods and elements disclosed herein are also compatible with measuring films, sheets, plaques, and the like produced through casting, extrusion, calender rolls, solution deposition, skiving, coextrusion, lamination, extrusion coating, spin coating, deposition coating, dip coating, the like, or a combination thereof.

The present teachings involve measuring the thickness of a film, sheet, plaque, or the like. Through these teachings, a thickness profile may be developed to provide a measurement of the thickness along an area of the film, sheet, plaque, or the like. The present teachings may be used to measure any thickness of the film. For example, the methods and equipment as discussed herein may be used to measure film thicknesses of about 1 micron or more, about 10 microns or more, or about 100 microns or more. The methods and equipment as discussed herein may be used to measure film thicknesses of about 100 m or less, about 50 m or less, or about 1 m or less.

The present teachings may include the use of hyperspectral imaging to determine the thickness and/or thickness profile of a film, sheet, plaque, or the like. Hyperspectral imaging may be used to provide these measurements without contacting the sample. Hyperspectral imaging may be used to determine how light interacts with the item being measured. Hyperspectral imaging may measure reflection, emission, and/or absorption of electromagnetic radiation. Hyperspectral imaging may also be known as chemical imaging, as it is possible to build systems to map uniformity of chemical compositions. Hyperspectral imaging may collect and process information from across the electromagnetic spectrum. Hyperspectral imaging may use spectroscopy to examine how light behaves in the film, sheet, plaque, or the like. Spectroscopy may be used to recognize materials based on their spectral signatures or the spectrum of the material. Development of a thickness profile may be achieved through obtaining both spectral and spatial information in each measurement simultaneously. These measurements may be provided in real time, allowing for data to be available quickly.

Hyperspectral imaging may include an instrument that splits incoming light into a spectrum. The instrument may be a spectrometer, a hyperspectral camera, hyperspectral sensors, or a combination thereof. Incoming light may be provided via a light source. During measurement of the film, the light source may be located on an opposing side of the film being measured as the camera to allow the camera to measure the light being transmitted through the film. The light source may be located on the same side of the film as the camera to allow the camera to measure the light being reflected by the film. The light source may be integrated into the camera or be attached thereto. It is contemplated that two or more cameras may be used with a single light source, or multiple light sources. For example, a light source may be located in one place with cameras located on opposing sides of the light source. A film or part of a film may be located between each camera and light source, which may allow for multiple films to be measured at once or multiple parts of the same film to be measured at once.

The light source may emit any type of light able to be received, detected, split, captured, and/or analyzed by the hyperspectral imaging instrument (e.g., spectrometer, hyperspectral camera, and/or hyperspectral sensor). While referred to herein as a hyperspectral camera, it is understood that this also includes hyperspectral sensors and/or a spectrometer. The light source may emit light and/or radiation having wavelengths on the electromagnetic spectrum. The light source may emit light and/or radiation having wavelengths within a range encompassing values of about 10 nm or greater, about 410 nm or greater, about 710 or greater, or about 780 or greater. The light source may emit light and/or radiation having wavelengths of about 1 mm or less, about 50,000 nm or less, or about 2500 nm or less. The light source may emit ultraviolet radiation and/or light. The light source may emit visible light. The light source may emit near-infrared (NIR) radiation and/or light. The light source may emit infrared radiation and/or light.

The camera may receive the light from the light source to provide spatial information, spectral information, or both, in each measurement. The hyperspectral camera may measure a plurality of spectra. The spectra may be used to form an image. Therefore, the hyperspectral camera may collect information as a set of images. These images may be combined, resulting in a three-dimensional hyperspectral cube, or data cube. The data cube may be assembled by stacking successive scan lines. Hyperspectral data cubes can contain absorption spectrum data for each image pixel.

The camera may measure points of thickness of the film in an image (e.g., a line image). The image may comprise a plurality of pixels. The hyperspectral camera may measure a plurality of spectra within the spectral range of the hyperspectral camera, creating the full spectrum for each pixel. The hyperspectral camera may measure spectra along the electromagnetic spectrum. The spectra may have a wavelength with a range encompassing values of about 10 nm or greater, about 410 nm or greater, about 710 or greater, or about 780 or greater. The spectra may have a wavelength of about 1 mm or less, about 50,000 nm or less, or about 2500 nm or less. The spectral images may have a wavelength in the ultraviolet range. The spectral images may have a wavelength in the visible light range. The spectral images may have a wavelength in the near-infrared (NIR) range. The spectral images may have a wavelength in the mid-infrared range. The spectral images may have a wavelength in the infrared range.

The hyperspectral camera may measure each pixel in an image (e.g., a line image) and may provide a spectral signature for each pixel. The number of pixels measured may depend on the camera used. For example, the line image may comprise about 10 or more pixels, about 20 or more pixels, about 100 or more pixels, about 200 or more pixels, or about 300 or more pixels. The line image may comprise about 1000 or fewer pixels, about 800 or fewer pixels, or about 500 or fewer pixels. The higher the number of pixels and the closer the camera is to the sample, the finer the spatial resolution. This may mean that there is a higher resolution when compared to measuring the same sample size or that a larger sample may be measured at the same resolution.

The camera for enabling hyperspectral imaging may use one or more operation modes. For example, line imaging mode or pushbroom mode may provide the necessary measurements and/or data to derive a thickness profile of the sample. In pushbroom mode, in each frame or picture, a line image may be collected from a line of a sample. The light from each spot, where the size may be determined by the distance between the camera and sample, the camera lens, and the camera itself, may be dispersed by the optics in front of the camera so that each frame has one dimension that is the spatial dimension and the other dimension is the spectral dimension simultaneously. While discussed herein as a line image, it is also contemplated that other shaped measurements are possible and within the present teachings. For example, the camera may capture an area having a rectangular shape, circular shape, oval shape, polygonal shape, amorphous shape, or a combination thereof at a single time.

In general, the camera and/or sensor may include an appropriate optical system using mirrors and lenses. For example, a hyperspectral camera and/or sensor may include a scan mirror, optics, a dispersing element, imaging optics, detectors or detector arrays, or a combination thereof. The camera used may depend on the number of pixels desired per measurement. The camera used may depend upon the spectra being measured. For example, for measuring or providing spectral images in the near-infrared range, a hyperspectral NIR camera may be used. The camera may be a short wave infrared (SWIR) camera. The camera may include a device for the movement of an electrical charge, such as a charge-coupled device (CCD).

When static samples or films are being measured, the camera may be translated in one or more directions to acquire a true two-dimensional chemical map. Where the samples or films are moving, for example, if the measurement is taken on-line, the motion of the sample may allow the two-dimensional chemical map to be acquired. The movement of the sample may be at a pre-set speed. The camera may be in a fixed position. The camera may be moving. If measuring a moving sample, the camera may move in the same direction or a different direction. For example, the camera may move in a direction generally perpendicular to the direction of movement.

One or more hyperspectral cameras and light sources may be employed while the film, sheet, plaque, or the like is being formed. The measurements may be performed in real time. This may allow for adjustment of the process or one or more process parameters (e.g., if changes must be made if the film is not meeting the required specifications). The measurement may allow for troubleshooting or determining which area of the process requires adjustment to provide a film that meets specifications.

One or more hyperspectral cameras and light sources may be positioned at various points along the line to ensure that the film meets required specifications throughout the process. For example, in a blown film process, a hyperspectral camera may be installed outside the bubble, with a light source mounted on the inner bubble cooling tube for measuring a single layer of the film directly. The camera may measure the bubble thickness vertically (i.e., in the machine direction), horizontally (i.e., in the cross-machine direction), or both. If measuring along the machine direction, so a line image is generated along the machine direction, it may be useful for determining thickness change and/or crystallization process, especially during the cooling process of the bubble. If measuring along the cross-machine direction, it may be possible to measure the gauge variation near the die exit. Such measurement may allow for providing fast feedback to the blown film line control system. It is possible that two or more cameras may be used to provide measurements of the bubble. For example, two or more cameras may be positioned around the diameter of the bubble. For example, three or more cameras, four or more cameras, or even six or more cameras may be used. Such cameras may be stationary. It is also contemplated that one or more cameras may be translatable or capable of movement. For example, a camera may be mounted to a rotational platform to scan the bubble (e.g., to rotate about the bubble). A camera may be capable of translating in the movement direction of the bubble or of the film production process. A camera may be capable of movement in any direction that would provide a valuable measurement.

One or more cameras may be positioned after the collapse of the bubble, forming a layflat, in a blown film process. The hyperspectral camera may be positioned at a point in the process after the nip rolls. The light source may be positioned on an opposing side of the film so the light waves travel through the film to the camera. This may allow for measuring the thickness of the layflat, to determine whether any wrinkles are present within the layflat, to determine whether any imperfections (e.g., bubbles, tears, inconsistencies in thickness) are present within the layflat, to determine whether any foreign particles are present or trapped within the layflat, the like, or a combination thereof.

Positioning of a camera and light source on-line or during the manufacturing process is not limited to blown film processes. A camera and light source may, for example, be positioned before or after a lamination process, extrusion process, a cutting process, a sheeter stacker process, a molding process, a stretching process, a winding process, a cooling and/or quenching process, a heating process, the like, or a combination thereof.

One or more cameras may instead, or in addition, be used to measure the film, sheet, plaque, or the like in an off-line setting. The sample may be measured after the material has been made, cut, removed from the processing equipment, or a combination thereof. The film may be positioned on a translation stage or other linear movement mechanism, for example, to measure the sample. The film may be held in position (e.g., between two or more elements holding the film taut) and measured. The film, or a portion thereof, may be measured while on the roll, or may be unrolled for measurement.

In measuring a plurality of pixels and spectra at a single time, data may be generated to identify the thickness of the film along the line. This data can be used to generate the thickness profile of the film. Since absorbance is linearly or directly proportional to the thickness of a material (and directly proportional to the concentration of the sample), by measuring the absorbance, the thickness of the material may be determined.

In obtaining and plotting the data, there may be interference or fringes. These fringes may hinder the interpretation and analysis of transmission spectra from the film samples. Fringes may be caused, for example, by wavelength-dependent constructive and/or destructive interference of the light traveling through the film and the reflected light by the two parallel film surfaces (e.g., in the instance of a layflat). To minimize the thickness prediction error due to such fringes, one or more mathematical approaches may be used. One approach may be using the classical least squares method (CLS). The CLS algorithm is based on a matrix operation that can be used to process hundreds of spectra almost instantaneously. The CLS method presumes that a sample spectrum is a linear combination of the spectra of its components. A fringe-free spectrum may be obtained by averaging multiple spectra to cancel out their fringes, or by measuring a film with rough surface. The fringes may then be treated as spectral residual. As fringes have intrinsic symmetry, its spectral contribution may cancel out when enough cycles of fringes are included.

Turning now to the figures, FIG. 1 illustrates a common approach to measuring the thickness of a film 10. As the film travels in the direction of the large arrow, measurements are taken using a scanner 12 (e.g., a near-infrared thickness scanner). Each measurement by the scanner 12 is a single point measurement 14 at a time. Since the film 10 is moving, the scanner 12 is only able to provide thickness information along a zig-zag path 16 on the surface of the film 10.

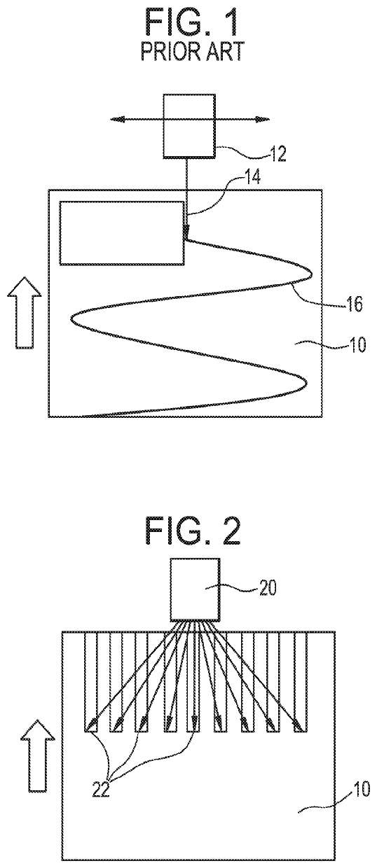

FIG. 2 illustrates measuring the thickness of a film 10 using a hyperspectral near-infrared camera 20. As the film travels in the direction of the large arrow, across the film cross-machine direction (CD direction), the camera 20 measures a plurality of points 22 for obtaining a thickness measurement. The camera 20 is therefore able to take a line image of the CD direction at any given time, which provides a whole film thickness profile, rather than at a single point or along a zig zag pattern, as compared to FIG. 1.

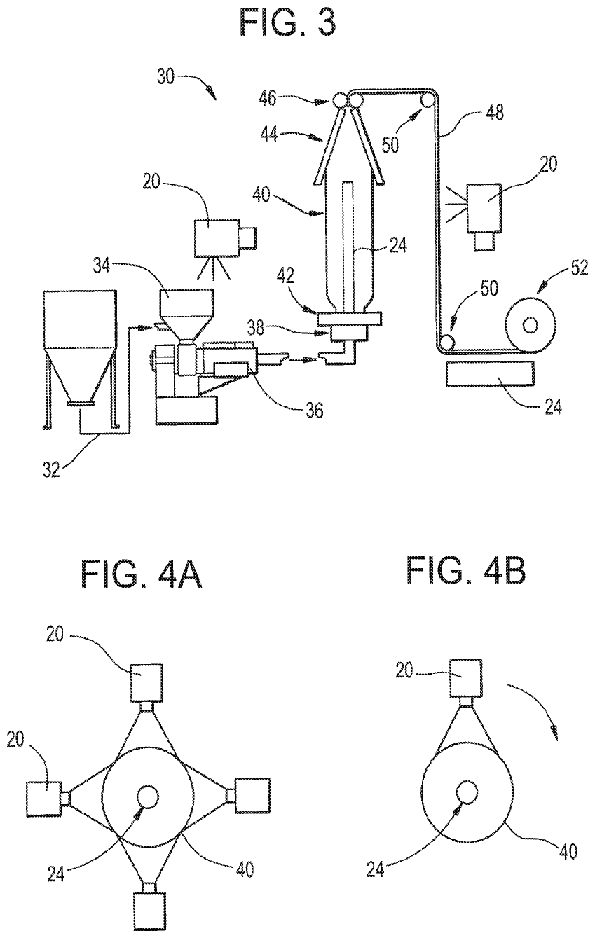

FIGS. 3A and 3B illustrate exemplary uses of hyperspectral NIR cameras during production of a film. The example in FIG. 3A shows a blown film line 30. In the process, resin or other materials 32 are introduced into a hopper 34. The materials are sent through an extruder 36. The extrusion of the melted material is done via a die 38 for the formation of a bubble 40. The introduction of air takes place through a hole present in the center of the die 38 for blowing up the bubble 40. The film is cooled by an air ring 42 mounted to the top of the die 38. The bubble 40 continues its upward travel until reaching a collapsing frame 44 and passing through nip rolls 46, which flatten the bubble to produce a dual-layer film or layflat 48. The layflat 48 is transferred via idler rolls 50 until it is rolled into a roll of film 52.

The thickness of the film may be measured at one or more points in the process. As shown, the thickness of the film forming the bubble may be measured by a hyperspectral NIR camera 20. The hyperspectral NIR camera 20 can measure the bubble 40 thickness vertically (machine direction or MD) or horizontally (cross machine direction or CD). When measuring the bubble thickness along the MD, this may be a helpful tool to understand the thickness change and crystallization process during cooling of the bubble. When measuring the CD, it can measure the gauge variation near the die exit, which may provide a fast feedback to the blown film line control system. An NIR light 24 is present within the bubble, mounted on the inner bubble cooling tube, to provide the light source needed for the camera 20 to capture the measurement. The thickness of the layflat 48 is also measured by a hyperspectral NIR camera 20 and an NIR light 24 located on the opposing side of the layflat 48.

FIGS. 4A and 4B illustrate potential setups to measure the bubble 40 cross machine direction (CD) gauge using a hyperspectral NIR camera 20 and NIR light 24 inside the bubble, mounted on the inner bubble cooling tube. FIG. 4A illustrates a plurality of stationary mounted hyperspectral NIR cameras 20 that can measure the entire bubble 40 at real time. While shown as four cameras, it is contemplated that any number of cameras can be used (e.g., three cameras, four cameras, six cameras). FIG. 4B illustrates a hyperspectral NIR camera 20 on a rotational platform to scan the bubble 40.

### ILLUSTRATIVE EXAMPLES

The following examples are provided to illustrate the present teachings, but are not intended to limit the scope thereof.

### Example 1

To illustrate the advantages of using a hyperspectral NIR camera to measure film, a hyperspectral NIR camera is compared with an x-ray scanner and a whole film surface profiler in three separate tests. Table 1 shows the results of each.

For the cases performed, the x-ray scanner is available from ScanTech. The x-ray scanner has a scan speed of 2 in/s, with 1024 measurements reported along the CD direction. The whole film surface profiler is a noncontact capacitance sensor available from SolveTech. Each sensor has a width of 1 inch. For Case 1, 6 sensors are used. For Case 2, 60 sensors are used. For Case 3, 216 sensors are used. The hyperspectral NIR camera is a SPECIM SWIR hyperspectral NIR camera having 384 pixels per line image, measuring 450 frames/second at a wavelength between 1000 and 2500 nm.

In Case 1, a 6-inch-wide film at 25 fpm film speed is measured. In Case 2, a 60-inch-wide film at 500 fpm film speed is measured. In Case 3, a 216-inch-wide film at 1000 fpm film speed is measured.

TABLE 1

| | | | | Avg Film | Avg Film | | | |
|---|---|---|---|---|---|---|---|---|
| | Film | Line | | Width of | Length of | Spot | MD | Film |
| | Width | Speed | | Measuring | Measuring | Size | Measurement | Measured |
| Case | in | fpm | Technology | Point, in | Point, in | mm² | Interval, s | % |
| 1 | 6 | 25 | x-ray | 0.006 | 0.015 | 0.055 | 3 | 0.1% |
| | | | whole film | 1.000 | 0.050 | 32 | 0.010 | 100% |
| | | | surface | | | | | |
| | | | profiler | | | | | |
| | | | NIR | 0.016 | 0.011 | 0.112 | 0.002 | 100% |
| | | | Camera | | | | | |
| 2 | 60 | 500 | x-ray | 0.059 | 2.930 | 111 | 30 | 0.1% |
| | | | whole film | 1.000 | 1.000 | 645 | 0.010 | 100% |
| | | | surface | | | | | |
| | | | profiler | | | | | |
| | | | NIR | 0.156 | 0.222 | 22 | 0.002 | 100% |
| | | | Camera | | | | | |
| 3 | 216 | 1000 | x-ray | 0.211 | 21.094 | 2871 | 108 | 0.1% |
| | | | whole film | 1.000 | 2.000 | 1290 | 0.010 | 100% |
| | | | surface | | | | | |
| | | | profiler | | | | | |
| | | | NIR | 0.563 | 0.444 | 161 | 0.002 | 100% |
| | | | Camera | | | | | |

Table 1 shows the advantage of a hyperspectral NIR camera over other technologies. The x-ray scanner only measures 0.1% of the whole film thickness in this case study. On the machine direction (MD direction), the x-ray will report after a significant time interval. For example, it takes 108 seconds to report the MD position thickness. In addition, on a high-speed film line, the x-ray reports an average thickness of a long film band (e.g., in Case 3, 0.2 inches wide and 21 inches long). The running average of thickness may already smoothen some variations.

In case of the whole film surface profiler, it is limited by the sensor width, though it reports all film surface. The sensor width may be 1 inch wide, but can be customized to a ½ inch. In Case 1, it will only report 6 thickness bands, or 12 thickness bands if using a ½ inch sensor, which is not very useful. In Case 3, since 216 sensors are required, this may not be economically viable.

For the hyperspectral NIR camera, it will measure all of the film surface with a very fast sampling rate in the MD direction (2 ms per measurement). Even in Case 3, it will report an average area on the film of 0.6 inch by 0.4 inch.

### Example 2

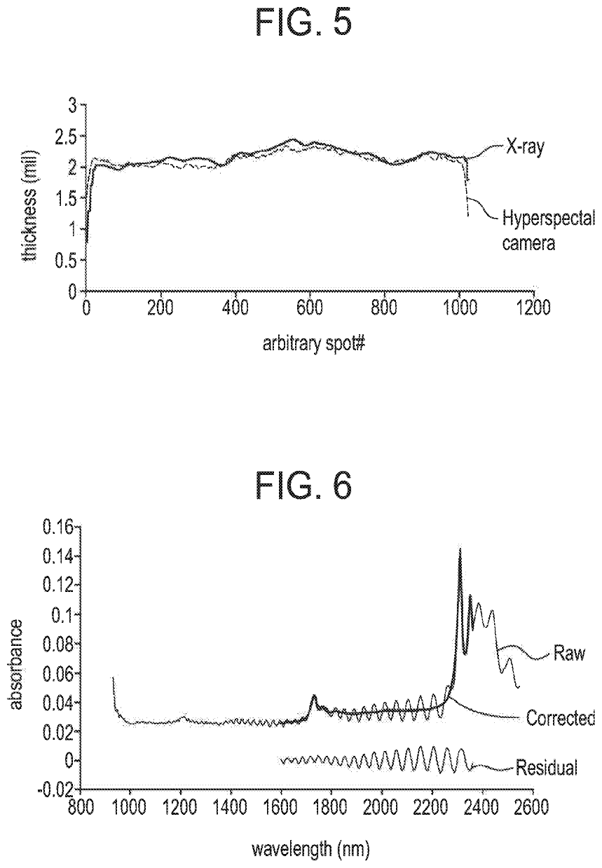

X-ray scanning is a common method for measuring thickness, despite its disadvantages as mentioned. FIG. 5 shows the results of a 0.05 mm (2 mil) high density polyethylene film (Dow Elite 5960G) having a width of 6 inches measured by an x-ray scanner and a hyperspectral NIR camera. The results match well, confirming that use of the hyperspectral NIR camera provides an accurate measurement of the thickness of the film. In FIG. 5, the dashed grey line represents the thickness measured by the hyperspectral NIR camera, and the solid black line represents the thickness measured by the x-ray scanner.

### Example 3

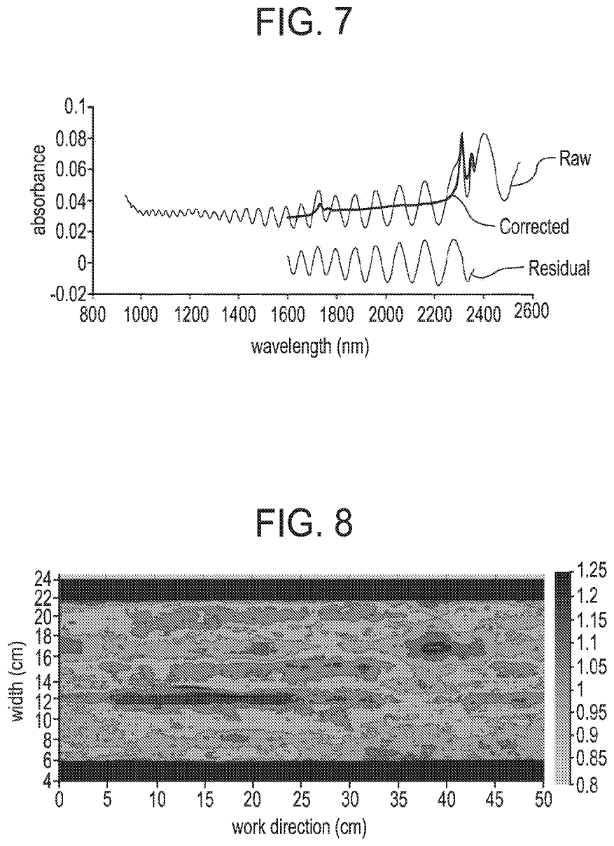

Using a hyperspectral NIR camera, two film spectra are obtained: one with 2 mil thickness, and one with 0.5 mil thickness. The data are plotted in FIGS. 6 and 7, respectively, showing the wavelength and absorbance. The raw data are shown as the indicated lines. However, spectral fringes are present in the data. To overcome such fringes, a classical least squares (CLS) analysis is used, assuming that a sample spectrum is a linear combination of the spectrum of its components. The fringes, therefore, are treated as a spectral residual. Since the fringes have an intrinsic symmetry, its spectral contribution should cancel out when enough cycles of fringes are included, which is satisfied due to the high periodicity of the fringes encountered. The corrected spectra, without fringe, using the CLS analysis are shown as the dark, bold lines in FIGS. 6 and 7. The spectral residual after CLS fitting is shown as the grey lines at the bottom of the graph in FIGS. 6 and 7. FIG. 8 illustrates a film thickness map based on the CLS analysis on a 15 cm by 50 cm (6 inch by 20 inch) film. The bar scale denotes the CLS response, with a response 1 corresponding to 0.05 mm (2 mil).

As can be appreciated, variations in the above teachings may be employed. For example, the present teachings are not limited to blown films or blown film processes. The present teachings can be used to measure other polymeric substrates other than films, sheets, and plaques. Other calculations or methods of removing fringes from data may be used. For example, the method of minimum sum, averaging adjacent spectra, nonlinear regression (e.g., a non-linear fitting algorithm), or the like, may be used.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consisting of, the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

Relative positional relationships of elements depicted in the drawings are part of the teachings herein, even if not verbally described. Further, geometries shown in the drawings (though not intended to be limiting) are also within the scope of the teachings, even if not verbally described.

1. A method comprising steps of:
a. obtaining a polymeric film, sheet, or plaque; and
b. measuring a thickness of the film, sheet, or plaque;
wherein the measuring step is performed using a camera collecting both spatial and spectral images of a plurality of points simultaneously.

2. The method of claim 1, wherein the camera collects a line image from a line of the film, sheet, or plaque.

3. The method of claim 1, wherein the film, sheet or plaque has thickness of 2 mm or less.

4. The method of claim 1, wherein the camera collects light having a wavelength of from 780 nm or greater to 2500 nm.

5. The method of claim 4, wherein a light source emitting light having a wavelength of from 780 nm or greater to 2500 nm is positioned on an opposite side of the polymeric film, sheet, or plaque than the camera.

6. The method of claim 5, further comprising the step:
forming the polymeric film using a blown film process.

7. The method of claim 6, wherein the blown film process comprises forming a bubble of film, and wherein the measuring step is performed on the bubble to determine the thickness of the film forming the bubble.

8. The method of claim 6, wherein the blown film process comprises collapsing a bubble of film to produce a layflat, and wherein the measuring step is performed on the layflat to determine the thickness of the layflat or one or more layers thereof.
